(19) United States
(12) Patent Application Publication
(10) Pub. No.: US 2026/0064373 A1
(43) Pub. Date: Mar. 5, 2026

(54) DISTRIBUTED CODE GENERATION AND EXECUTION FOR REAL TIME MARINE APPLICATIONS

(71) Applicant: NEC Laboratories America, Inc., Princeton, NJ (US)

(72) Inventors: Giuseppe Coviello, Robbinsville, NJ (US); Kunal Rao, Monroe, NJ (US); Gennaro Mellone, Napoli (IT); Ciro Giuseppe DeVita, Naples (IT)

(21) Appl. No.: 19/299,719

(22) Filed: Aug. 14, 2025

Related U.S. Application Data
(60) Provisional application No. 63/687,870, filed on Aug. 28, 2024.

(51) Int. Cl. G06F 8/30

(52) U.S. Cl. CPC G06F 8/311

(57) ABSTRACT

Systems and methods for executing code. The systems and methods include generating code by querying a model wherein one portion of the code is conditioned on an output on a second portion of the code, analyzing functions in the code with a second model to evaluate opportunities to implement tasks on devices, marking the code to designate portions of the code that can be performed on the devices, and assigning portions of the code to the devices based on capabilities of the devices. The systems and methods further include distributing the portions of the code to the devices, wherein the conditional portion of the code is distributed onto a first device and the second portion is distributed onto an edge device, executing the code across the devices, and transmitting data collected by the edge device to the first device upon meeting the condition in the code.

### RELATED APPLICATION INFORMATION

This application claims priority to U.S. Provisional Patent Application No. 63/687,870, filed on Aug. 28, 2024, incorporated herein by reference in its entirety.

### BACKGROUND

### Technical Field

The present invention relates to generative artificial intelligence and more particularly generating computer code for execution in remote settings.

### Description of the Related Art

Robots such as Unmanned Surface Vehicles (USVs) equipped with sensors are routinely sent to remote locations to collect information and perform other missions. These robots can have limited volumetric or payload capacity to house hardware. Additionally, communicating with the robots when they are at these remote locations can be difficult due to limited connectivity. This means that the robots can have limited memory space for storing collected data or random access memory (RAM), electrical power for maintaining robot operations and data processing, computing power for executing sophisticated data processing algorithms, communication capabilities for sending information to a cloud, etc. Dividing data processing related to the data collected from the robot between the robot and a cloud environment can mitigate the hardware and connectivity limitations.

### SUMMARY

According to an aspect of the present invention, a method is provided for generating and executing distributed code. The method includes generating serial code by querying a trained model wherein at least one portion of the serial code is conditioned on an output on a second portion of the serial code, analyzing code functions in the serial code with a second trained model to evaluate opportunities to implement tasks on a plurality of computer devices over a network, marking the serial code with indicators to designate portions of the serial code that can be performed on the plurality of computing devices, and assigning portions of the serial code to the plurality of computing devices based on capabilities of the plurality of the computing devices. The method further includes distributing the portions of the serial code to the plurality of computing devices, wherein the conditional portion of the serial code is distributed onto a first device and the second portion of the serial code is distributed onto an edge device, executing the serial code across the plurality of computing devices using an execution engine to coordinate execution across the plurality of computing devices, and transmitting data collected by the edge device to the first device upon meeting the condition in the serial code.

According to another aspect of the present invention, a system is provided for generating and executing distributed code. The system includes a processor and a memory storing computer-readable instructions. The memory causes the processor to generate serial code by querying a trained model wherein at least one portion of the serial code is conditioned on an output on a second portion of the serial code, analyze code functions in the serial code with a second trained model to evaluate opportunities to implement tasks on a plurality of computer devices over a network, mark the serial code with indicators to designate portions of the serial code that can be performed on the plurality of computing devices, and assign portions of the serial code to the plurality of computing devices based on capabilities of the plurality of the computing devices. The memory further causes the processor to distribute the portions of the serial code to the plurality of computing devices, wherein the conditional portion of the serial code is distributed onto a first device and the second portion of the serial code is distributed onto an edge device, execute the serial code across the plurality of computing devices using an execution engine to coordinate execution across the plurality of computing devices, and transmit data collected by the edge device to the first device upon meeting the condition in the serial code.

According to yet another aspect of the present invention, a computer program product is provided for generating and executing distributed code. The computer program product includes computer program code that when executed by one or more processors causes one or more processors to perform operations. The computer program product includes instructions to generate serial code by querying a trained model wherein at least one portion of the serial code is conditioned on an output on a second portion of the serial code, analyze code functions in the serial code with a second trained model to evaluate opportunities to implement tasks on a plurality of computer devices over a network, mark the serial code with indicators to designate portions of the serial code that can be performed on the plurality of computing devices, and assign portions of the serial code to the plurality of computing devices based on capabilities of the plurality of the computing devices. The computer program product also includes instructions to distribute the portions of the serial code to the plurality of computing devices, wherein the conditional portion of the serial code is distributed onto a first device and the second portion of the serial code is distributed onto an edge device, execute the serial code across the plurality of computing devices using an execution engine to coordinate execution across the plurality of computing devices, and transmit data collected by the edge device to the first device upon meeting the condition in the serial code.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating an application of the distributed code generation and execution, in accordance with an embodiment of the present invention;

FIG. 2 is a block diagram illustrating a high-level system for code generation and execution, in accordance with an embodiment of the present invention;

FIG. 3 is a block diagram illustrating a system for training a Large Language Model (LLM) code generator, in accordance with an embodiment of the present invention;

FIG. 4 is a block diagram illustrating a system for refining a system prompt for LLM code generation, in accordance with an embodiment of the present invention;

FIG. 5 is a block diagram illustrating a system for generating distributed code, in accordance with an embodiment of the present invention;

FIG. 6 is a block diagram illustrating execution of distributed code, in accordance with an embodiment of the present invention;

FIG. 7 is a flow diagram illustrating a method for performing distributed code generation, in accordance with an embodiment of the present invention;

FIG. 8 is a block diagram illustrating a system for generating and executing distributed code, in accordance with an embodiment of the present invention; and

FIG. 9 is a block diagram illustrating an artificial neural network for employing LLMs, in accordance with an embodiment of the present invention.

### DETAILED DESCRIPTION OF PREFERRED EMBODIMENTS

Embodiments of the present invention can include a large language model (LLM) based tool which automatically generates a distributed version of code and a component that understands the program semantics and executes independent tasks within the program on a cluster of computing devices. Other solutions to optimize LLM generated code have attempted to generate parallel code but focus on low-level parallelization such as optimizing for multiple cores or unique characteristics of the central processing units (CPU) or graphics processing unit (GPU) architecture. Embodiments of the present invention take advantage of multiple computing devices, each having GPUs to distribute execution of code. Though use of multiple computing devices is not necessary.

In an embodiment of the present invention, the computing devices can be clusters, computers, edge devices, internet of things (IoT) devices, servers, setups, machines, etc. Each computing device can be a GPU, CPU, tensor processing unit (TPU), neural processing unit (NPU), other application specific integrated circuit (ASIC), field programmable gate array (FPGA), etc., or any combination thereof. The specific hardware that the computing device is housed on can be located at a single location or at several locations or a combination thereof.

In embodiments of the present invention, the LLM-based tool analyzes dependencies in the serial code and evaluates whether there are opportunities to implement the same tasks in parallel. Once these opportunities are discovered, the code is marked with semantics so that the code can be performed on several computing devices. In other words, the program can have one set of processes performed on a different device than other processes and the devices know which portion to execute based on indications in the code.

For example, an Application Programming Interface (API) and other finer granularity/low-level compiler optimization techniques, e.g., vectorization, loop unrolling, instruction level parallelism, etc. can improve computational efficiency. The processes can be performed on separate pieces of hardware (e.g., devices). Each API call is considered as a task, and the LLM-based tool transforms the code such that independent tasks can be distributed and run in parallel, as opposed to sequentially, which is what occurs when serial code is performed (and the code is performed on a single piece of hardware).

The distributed version of the code generated by the LLM-based tool follows specific program semantics, which can be understood by an underlying runtime. Once the distributed code is generated by the LLM-based tool, the runtime component understands the program semantics and efficiently executes independent tasks within the program on a distributed computing devices in the proper order.

In an embodiment of the present invention, an artificial intelligence (AI) model being trained or executed on a cluster of computing devices can apply parallel tasks well and is suitable for using distributed code generation. AI models often compute the same type of calculation many times and can utilize GPUs because GPUs are designed to process the same task many times and can be stored on several different computing devices. This can be more efficient than performing the same task on a single computing device which may use a CPU instead, which is less efficient at performing the same task repetitively.

AI models can perform any number of tasks such as image classification, object detection, segmentation, pose estimation, speech recognition, speaker identification, sound event detection, named entity recognition, sentiment analysis, semantic similarity, text generation, code generation, machine translation, summarization, image synthesis, video generation, text to speech, music generation, game-playing, robotics control, route optimization, multi-agent coordination, symbolic reasoning, theorem proving, multi-hop question answering (QA), commonsense reasoning, recommender systems, dialogue agents, personal assistants, adaptive learning systems, anomaly detection, time series forecasting, clustering/classification/regression, feature selection and dimensionality reduction, etc. This is not intended to be limiting, and this list is non-exclusive.

In some embodiments of the present invention, code generation can be associated with Synthia and code execution can be associated with Hermod.

Embodiments of the present invention can employ an edge+cloud computing environment. This is because edge computing has emerged as a technology in real-time and latency-sensitive applications, especially in environments where connectivity to cloud infrastructure may be limited or costly. However, edge-only systems are sometimes limited by their onboard hardware, unable to execute sophisticated AI models that require more GPU memory or computational power than available. Conversely, cloud-only systems require the continuous transmission of full-resolution data to remote servers, which can become prohibitively expensive and not very reliable, particularly in bandwidth-constrained environments. Hybrid edge-cloud systems address this balance between local processing power and cloud resources. These systems, such as federated learning frameworks or task-offloading solutions, split the computational workload between the edge and cloud infrastructure, achieving a balance between low latency and high computational capability, and limiting the amount of data transfer from edge to cloud.

Embodiments of the present invention include a hybrid edge-cloud systems by distributing tasks between the edge and the cloud, processing lightweight models locally on the edge, and sending some data, such as image crops, to the cloud, where large AI models are run. Selective image cropping significantly optimizes both latency and cost for operating real-time. Embodiments of the present invention can reduce the need for virtual machines by reducing the processing on a server. This can reduce costs by allowing the user to use a less GPUs or less complex GPUs on a virtual machine from a server to perform tasks by having some of the less involved, but more common tasks performed on the edge computing device and have computationally heavy but uncommon tasks performed on the cloud. In other words, this freedom allows the user to use any number or combination of GPUs to perform a given task.

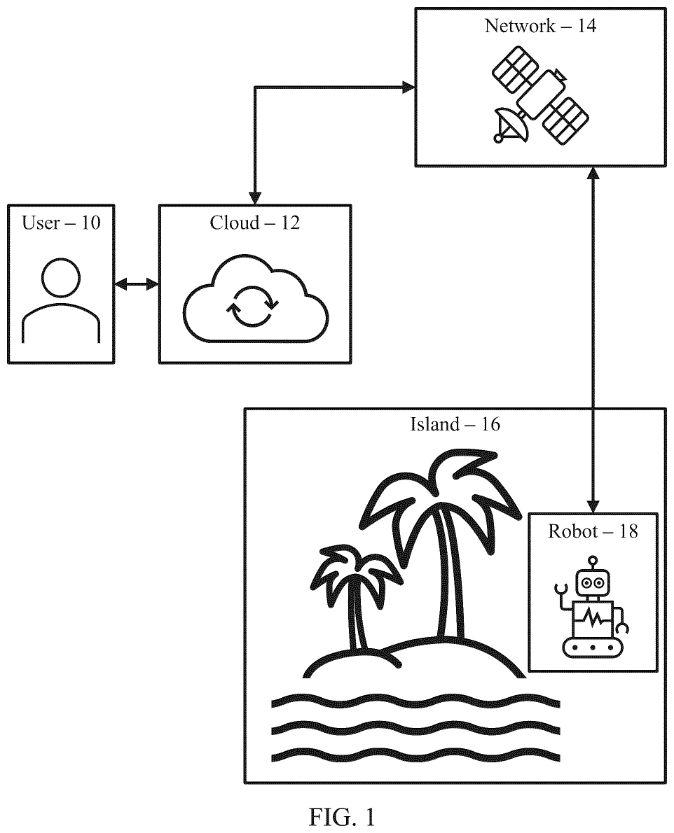

Referring now in detail to the figures in which like numerals represent the same or similar elements, and initially to FIG. 1, a block diagram for employing distributed code for operation of a remote robot 18 is demonstrated. A land-based user 10 can interact with a cloud 12 environment. Cloud 12 can include GPUs, CPUs, AI models, memory, networking/communication/transmission capabilities, software, databases, etc. The AI models can include LLMs, VLMs, other generative artificial intelligence (GenAI) models, other artificial neural networks (ANNs), etc.

Cloud 12 can be connected to network 14. The connection can be through satellite, as depicted in FIG. 1, Bluetooth®, Wi-Fi®, NFC®, 4G/5G wireless network capabilities, etc. Network 14 can also be connected to robot 18 which is on island 16. Island 16 can be a location that is remote, isolated, desolate, inaccessible, dangerous, or otherwise call for robot 18 instead of user 10. While island 16 is depicted in FIG. 1, other embodiments can be on the ocean surface, within the ocean, outside of Earth's atmosphere, in caves or forests, or other locations. Robot 18 can have any combination of sensing and sample collection capabilities, navigation capabilities, processing capabilities, communication capabilities, storage capabilities, locomotion capabilities, visual and audio emitting capabilities, etc.

Robot 18 can have CPUs, GPUs, or other processing units. Robot 18 can have cameras, heat sensors, microphones, LiDAR, RADAR, SONAR, etc. In situations where the processing power on robot 18 is limited, cloud 12 can have processing power to supplement robot 18. In an embodiment of the present invention, user 10 communicates with robot 18 through cloud 12 and network 14. In embodiments of the present invention, cloud 12 can be part of network 14 or network 14 can be part of cloud 12.

User 10 can prompt cloud 12 to have robot 18 execute a task. Cloud 12 can take the prompt and form serial code and distributed code to reflect the request in the prompt. The distributed code can be distributed so a portion can be performed on robot 18 while the remainder can be performed on cloud 12. The portions on robot 18 and cloud 12 can vary depending on the tasks assigned, network 14 connectivity, and other factors. For example, data processing intensive requests from user 10 can allocate more of the processing to cloud 12 than robot 18. In some embodiments of the present invention, cloud 12 has more processing power than robot 18. The allocation of data processing can be affected by the processing power on robot 18. If there is enough processing power on robot 18, then robot 18 can process more of the data.

Robot 18 can reduce the amount of data processing and data manipulation while the majority or a larger portion is performed by cloud 12. Memory, power capacity, transmission capabilities, and other factors can also be factored into consideration of the data processing allocation between cloud 12 and robot 18.

User 10 can prompt cloud 12 to do a variety of tasks such as “locate and record images of litter,” “document all tide pools,” or “warn unauthorized ships that they are in restricted waters and notify me.” In these tasks, and other tasks contemplated by embodiments of the present invention, detecting the presence of objects can be more common and easier than identifying objects. In other words, finding potential objects that look like “litter,” “tide pools,” and “unauthorized ships” can be more common and easier than finding objects that actually are “litter,” “tide pools,” and “unauthorized ships.”

This means that the function of detecting potential “litter,” “tide pools,” and “unauthorized ships” occurs more frequently, and can be less computationally expensive than, actually identifying if the objects are what robot 18 believes they are. The initial recognition of an object can be performed on robot 18, the images or other data can be sent in their original form or reduced in size or complexity to cloud 12 for object detection to determine if the objects are “litter,” “tide pools,” and “unauthorized ships.” To put this another way, the code can include conditional dependencies to for downstream processing.

Other information can also be transmitted to cloud 12 as well like metadata, or other predetermined data like sensor readings. For the “litter” and “tide pools” the objects can be “recorded” and “documented” automatically once cloud 12 determines that the objects are “litter” or “tide pools.” For “unauthorized ships,” once cloud 12 determines the ship is “authorized” or “unauthorized,” cloud 12 can transmit a response to robot 18. The response can be “take no action,” or “warn ship.” Other responses and actions are also contemplated include “capture additional images” or “approach ship,” respectively.

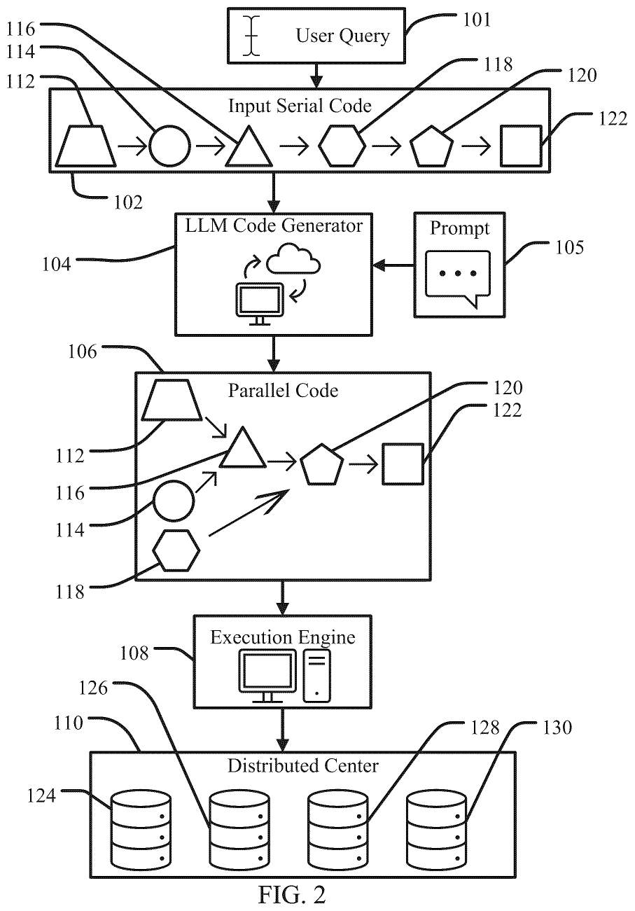

Referring to FIG. 2, a high-level architecture of the code generation framework is illustrated. The LLM-based tool can be an LLM code generator 104 which focuses on improving the performance of the input serial code 102. Performance of the input serial code 102 can be defined as the time taken to execute the code and generate an output (e.g., latency of code execution).

LLM code generator 104 can leverage concepts from parallel processing and generate distributed code which decomposes input serial code 102 into parallel tasks that can be performed on different computing devices most effectively. The parallel tasks that were in originally input serial code 102 can then be executed concurrently or at least partially concurrently on a cluster of computing devices, though they can be performed serially on different computing devices. In other words, embodiments of the present invention have more of an effect on high-level algorithmic improvements than actual implementation of the code itself (e.g., low-level algorithmic improvements). This improves the functioning of a computer by separating tasks. In situations where the network is made up of different types of GPUs made for different purposes, the distributed code can be generated to consider this can allocate GPU to tasks accordingly. More common, simpler, or tasks towards the beginning of data processing can be allocated to computing devices differently. For example, data collection, data augmentation, and some data processing can be performed on a computing device that has less computing power than other data processing functions. The edge computing device data processing can include image recognition or other tasks that can initiate downstream processing depending on the output.

LLM code generator 104 uses a parallel computation model for execution on multiple computing devices rather than serial code execution, which occurs on a single computing device. This is because a distributed cluster 110 that performs parallel code 106 can be tasked with performing the same portion of the functions of the code many times (instead of all the functions in the code) such as training a neural network. GPUs are optimized for performing the same task instead of a variety of tasks, and there are efficiencies in economies of scale over performing input serial code 102 with CPUs, making parallel computing with GPUs preferable to serial computing. Distributed cluster 110 can have components on network 14 and robot 18 (FIG. 1). While embodiments of the present invention describe robot 18 (FIG. 1), the computing device does not need to have movement capabilities. In other words, the computing device can be stationary.

LLM code generator 104 leverages generative artificial intelligence (GenAI) and LLMs to automatically generate distributed version of input serial code 102 according to a user query 101. User queries 101 and prompts 105 can be natural language inputs, images, videos, audio, or another types of input that the LLM is capable of processing. User query 101 is the desired goal in non-technical terms (though user query 101 can be in technical terms if preferred), while prompt 105 is machine generated input to an AI model to generate parallel code 106.

LLM code generator 104 includes an LLM which is trained to automatically transform input serial code 102 into parallel (distributed) code 106 which can be executed on distributed cluster 110. Input serial code 102 can be generated by any number of LLMs.

Input serial code 102 and parallel code 106 can be written in any number of computer languages including C/C++, Python, Java, JavaScript/TypeScript, C#, Go, Rust, Swift, Kotlin, Ruby, PHP, Perl, SQL, etc. Other languages are also contemplated, and this list is intended to be illustrative and non-limiting.

To execute tasks on separate computing devices, the LLM code generator 104 uses special program semantics, which use function calls to “services” on the component. The program semantics indicate which section of the code can be executed on a given computing device, separate from the others. The component can be an execution engine 108. Execution engine 108 can receive and execute parallel code 106 on distributed cluster 110. Through function calls, independent tasks can be executed in parallel on distributed cluster 110. The function calls can be independent API calls. This allows for dynamic, flexible, and adaptable code execution systems. For example, computing devices can be called for certain tasks or functions and otherwise available for other functions. In other words, the computing devices can be pooled such that they can be called by different entities performing different tasks. These computing devices can be employed when there is code to execute and be on standby otherwise so that other entities can perform other functions with the same computing devices at a later time or concurrently. Alternatively, depending on other system factors different computing devices can be employed to perform the same task. To put this another way, e.g., if a computing device is preferred to execute a certain function but is allocated to another, unrelated task or function, a different computing device can be assigned to perform the given function, rather than waiting for the preferred computing device. Execution engine 108 can call to have portions of the code performed on robot 18 while the remainder is performed on cloud 12 (FIG. 1).

In one embodiment of the present invention the code can be generated and executed in Python programing language and use the “asyncio” library to execute code concurrently. Other methodologies and similar or equivalent libraries in other languages are also contemplated such as, e.g., Trio, Curio, Twisted, Tokio, etc.

Generally, LLMs require proper guidance through prompts 105 to achieve the desired results. In some embodiments of the present invention, prompt 105 can be engineered to form parallel code 106 that can be executed in parallel by forming specific signals in the code to perform selected functions or portions of the code concurrently. Parallel code 106 is formed from prompt 105 and input serial code 102 while user query 101 is used to form input serial code 102. These signals can be functions from a module in the programming language that allows code to be executed concurrently. Other signals are also contemplated.

In embodiments of the present invention, user query 101 is intended to denote the input that derives input serial code 102 and prompts 105 are inputs to LLM code generator 104 that derive parallel code 106. Since LLMs are quite sensitive to prompt 105 (and user query 101), rather than manually writing prompt 105, a training phase in LLM code generator 104 automatically generates a system prompt 105. System prompt 105 will guide the LLM to generate syntactically correct and performant distributed code for the given input serial code 102 (while ensuring that parallel code 106 performs the same functions as input serial code 102). Syntactically correct can mean that the program syntax can be correct and the program can run. Performant can mean the code can take advantage of the parallelism in the distributed code and run faster than the serial version.

The tasks performed in input serial code 102 and parallel code 106 are illustrated as shapes in sequential order. In input serial code 102 the first function to be performed is a trapezoid 112, then a circle 114, then a triangle 116, then a hexagon 118, then a pentagon 120, and then a square 122. This linear process can be separated onto several different computing devices to make the code more efficient through parallel processing. Instead, trapezoid 112, circle 114, and hexagon 118 can be performed at the same time (in parallel) on different computing devices which can reduce the execution time of the code. Further, these computing devices can be configured to optimize each process on them through the selection of specific hardware or other means Computing devices can be configured and optimized to serve specific API calls. Embodiments of the present invention can have the initial processing on robot 18 (FIG. 1) occur before any parallel processing occurs. Parallel code 106 can have parallel processing occur once the initial data is transmitted to cloud 12 (FIG. 1) via network 14 (FIG. 1).

Trapezoid 112 can embody code such as, e.g., defining variables, etc. Circle 114 can perform other operations concurrently with trapezoid 112, such as, e.g., importing modules. Triangle 116 can then execute the function defined using the variables from trapezoid 112 and a module from circle 114. While trapezoid 112 and circle 114 are being performed, hexagon 118 can also be performed concurrently since there is no dependency on hexagon 118 from triangle 116. The output from triangle 116 and hexagon 118 can then be combined in pentagon 120. The output from pentagon 120 can then be displayed graphically or returned in square 122.

In an exemplary embodiment of the present invention, execution engine 108 can use four servers, server one 124, server two 126, server three 128, and server four 130. While three actions at most can be performed at one in the code illustrated in FIG. 2, an additional server may be present to supervise the other servers, perform other tasks, provide redundancy, or otherwise be used. Server one 124 can perform the function described in trapezoid 112 while server two 126 can perform the function described in circle 114 and server three 128 can perform the function described in hexagon 118. In alternative embodiments of the present invention, the servers can be optimized for a given task or can perform the next task in the sequence.

To be clear, embodiments of the present invention can be integrated with low-level optimization of the code which make each of the functions represented by the shapes more efficient. Embodiments of the present invention change when and where the code is executed (e.g., concurrently on different machines), not but not the manner in which the code is executed, which can be improved by other techniques in conjunction to those mentioned herein.

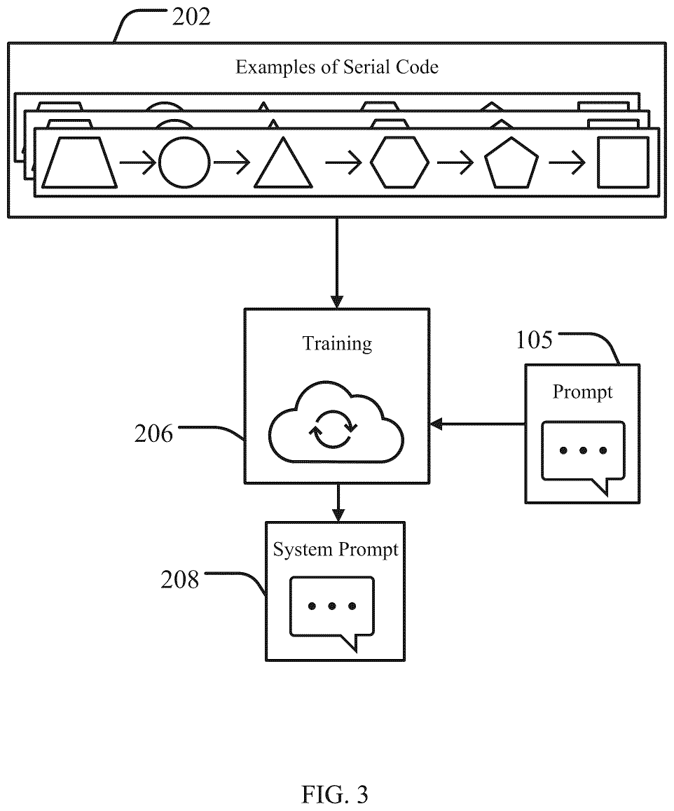

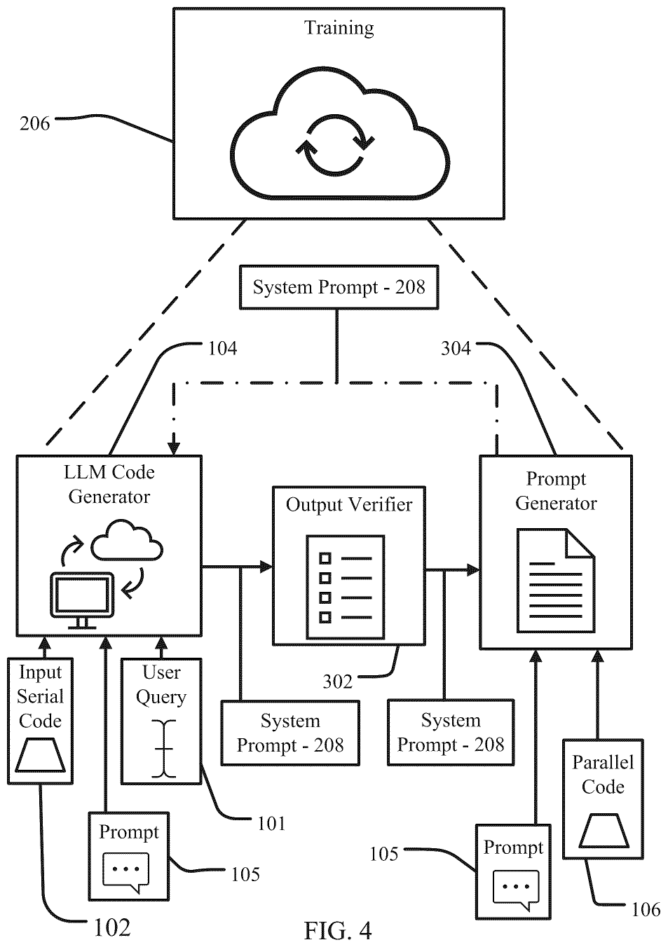

Referring to FIGS. 3 and 4, block diagrams of the training of LLM code generator 104 are illustrated in greater detail. The goal of training phase 206 is to derive a system prompt 208 which, given input serial code 102 and prompt 105, generates syntactically correct and performant parallel code 106 (FIG. 2), which can be executed on a distributed cluster 110 (FIG. 2). Input to training phase 206 includes several example serial codes 202 along with corresponding prompt 105 for which there is a known ground truth output. The known ground truth is the generated output from the serial code which can be compared with the output from the generated distributed code.

Training phase 206 is started with a basic seed prompt (prompt 105) and iteratively revises prompt 105 automatically until syntactically correct and performant versions of the parallel code 106 (FIG. 2) are generated. Parallel code 106 (FIG. 2) can perform the same functions as the equivalent code in the several examples of serial code 202 and do so faster. Embodiments of the present invention maintain the accuracy and functionality of several examples of serial codes 202 while improving the code by reducing runtime (e.g., making the runtime faster). In other words, parallel code 106 has no functionality, operability, or other degradation in code quality (to a reasonable, predetermined degree, if at all).

To implement training phase 206, a plurality of different LLMs (e.g., three) can be employed. LLM code generator 104 generates distributed code for user query 101 and several example serial codes 202 based on prompt 105. During training phase 206, the prompt 105 for LLM code generator 104 continues to be revised. Revision occurs whenever prompt 105 cannot generate syntactically correct and performant parallel code 106 (FIG. 2).

Another LLM used is output verifier 302 which compares an output for a given system prompt 208 in several example serial codes 202 with an output for a given system prompt 208 in parallel code 106 (FIG. 2) and determines whether they match. If prompt 208 matches, then system prompt 105 for LLM code generator 104 stays constant, if not, another LLM is invoked to revise prompt 105.

A different LLM used during training phase 206 can include prompt generator 304 which refines prompt 105 for LLM code generator 104 whenever the generated distributed code does not pass the standards of output verifier 302. Input to prompt generator 304 can include prompt 105, incorrect parallel code 106, and output from the serial and distributed code execution (system prompt 208). With these inputs, prompt generator 304 analyses the reason prompt 105 was not able to generate a satisfactory version of parallel code 106 and then derives a new system prompt 208, which matches input serial code 102 better. Once training phase 206 is complete, LLM code generator 104 and prompt 105 are aligned to automatically generate parallel code 106.

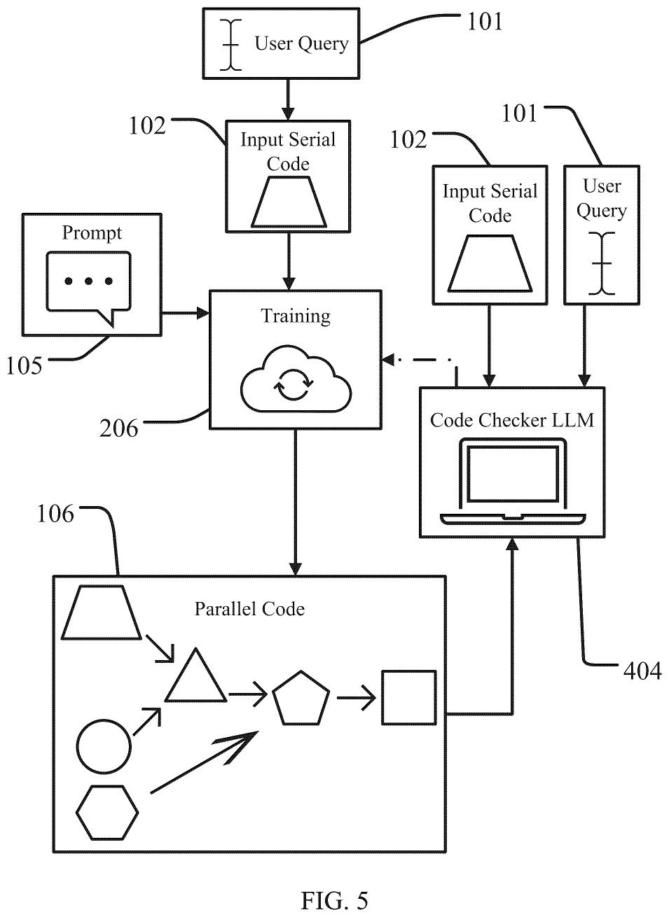

Referring to FIG. 5, a block diagram for inference generation of the LLM-based tool is illustrated. Once parallel code 106 is generated, the code is tested to determine whether the code is suitable for deployment or other use. To validate the performance of parallel code 106 another LLM is used. Code checker LLM 404 has as inputs user query 101, input serial code 102, and parallel code 106. With these inputs, code checker LLM 404 compares the two codes and determines whether parallel code 106 can generate the same output as input serial code 102. If the code passes, then the suggested parallel code 106 is given as the final output. If not, then another version of parallel code 106 is generated and compared. This continues until a suggested parallel code 106 version passes.

In further detail, several serial code 102 examples are executed to achieve output for verification purposes. For each input serial code 102, a corresponding parallel code 106 is also generated, with a corresponding output. Then, the two outputs are compared. If parallel code 106 is faster than the input serial code 102 (performant) and the outputs match, then the next input serial code 102 example is tested. If not, then a new prompt 105 is generated and applied to LLM code generator 104. The failed test is repeated until a configured maximum number of attempts to determine if the test is passed, e.g., generated parallel code 106 is performant and the output matches input serial code 102. Whenever a previously failed test passes, the process is repeated from the beginning to ensure that the refined system prompt 105 has not changed behavior for previously passed tests. This process continues until all tests pass for a minimum configured number of times. Once completed, the last system prompt 105 is used as the final instructions.

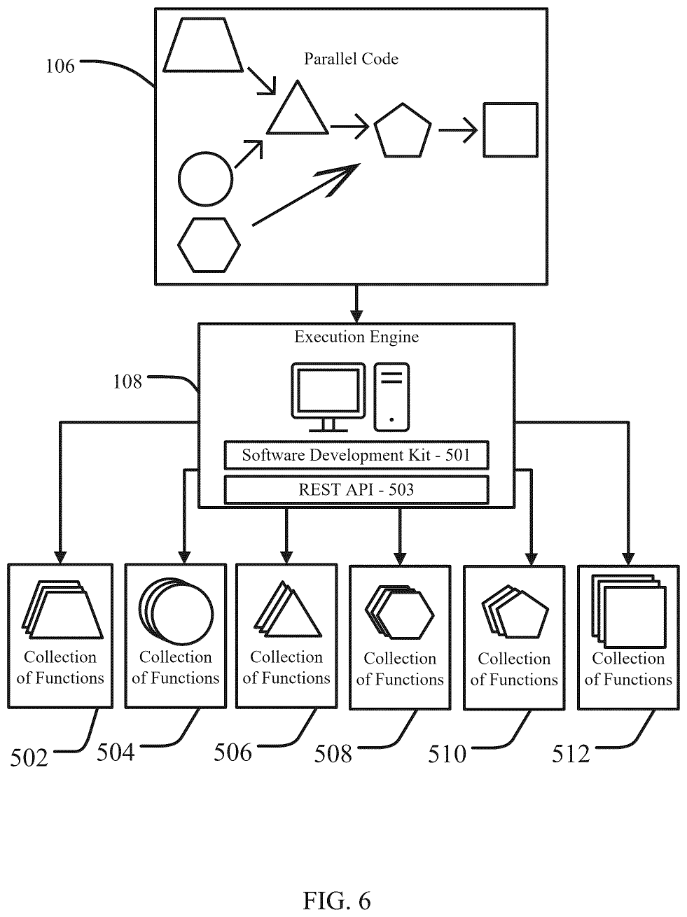

Now referring to FIG. 6, execution engine 108 is described in further detail. While LLM code generator 104 (FIG. 2) automatically generates a distributed version of input serial code 102 (FIG. 2) to improve code performance, execution engine 108 focuses on efficient execution of the generated parallel code 106 on a set of distributed computing devices, e.g., cluster of computer devices (distributed cluster 110). Input to execution engine 108 is the parallel code 106 generated by LLM code generator 104.

Since LLM code generator 104 is aware of the underlying runtime, parallel code 106 already incorporates special program semantics to invoke function calls to “services” on execution engine 108. These function calls are understood by execution engine 108 and executed efficiently on the underlying distributed infrastructure (e.g., distributed cluster 110). These function calls are indications in parallel code 106 that separate the code into different computing devices. In other words, the function calls are indicators in the code that reflect when parallel operations can be performed. In some embodiments of the present invention. programming language libraries can be imported into the code and have functions to indicate which functions can be performed concurrently.

In some embodiments of the present invention, execution engine 108 can be paired with third-party solutions, such as, e.g., Kubernetes, though third-party solutions are not necessary. The third-party solutions can be container orchestration frameworks that act as an “operator” to package, deploy, and manage Kubernetes applications. The operator exposes a new “kind” called “function,” through which various functions as a “service” can be deployed on the third-party solution. The “kind” is installed in Kubernetes to create clusters using docker container nodes. The “service” exposes a set of pods as a network service. These functions are stateless and serverless since execution engine 108 manages the computing devices and is transparent to the source writing or function invoking.

Various functions can be deployed on execution engine 108, each performing a specific task (e.g., portion of parallel code 106 that is on a separate computing device). Each function forms a “deployment” and execution engine 108 creates multiple copies/instances of each function and executes them as “pods” within the third-party solution. There are several ways to invoke a function that runs on execution engine 108. For example, several copies of the function represented by trapezoid 112 can form collection of functions 502. A collection of functions 504 can be for circle 114, a collection of functions 506 can be for triangle 116, a collection of functions 508 can be for hexagon 118, a collection of functions 510 can be for pentagon 120, and a collection of functions 512 can be for square 122.

One approach to invoke the function includes applying a Software Development Kit 501 (SDK). A purpose of SDK 501 is to provide a collection of tools, libraries, documentation, code samples, processes, guides, etc., which can create applications integrated into specific third-party platforms, operating systems, frameworks, or programming languages. SDK 501 is generally developed by a third-party. Execution engine 108 exposes the SDK 501 to implement different functions/services. In other words, SDK has a “run” function, which takes in a callback function as an argument (parallel code 106). Execution engine 108 invokes this callback function whenever there is a request on a particular function/service as determined by LLM code generator 104.

Another way to invoke the function that runs on execution engine 108 includes a representational state transfer (REST) API 503 which also allows interfacing with the function/service. The execution engine 108 exposes functions and services via dedicated endpoints. Upon receiving a “POST” request with the proper parameters/inputs, the execution engine 108 processes POST request and returns a response.

To execute requests received on different functions/services (either through SDK or REST API), execution engine 108 internally maintains a queue for each function/service. Whenever a request is received for any function, the request is put at the end of the queue corresponding to the function. Each queue is processed independently to serve function requests. Execution engine 108 maps each request to one of the available copies (“pods”) of the function and executes them on a first-come, first-serve basis. At the time of execution, if the request is no longer valid, e.g. if the sender no longer needs the response, then execution engine 108 automatically removes the request from the queue. By having separate queues and processing requests concurrently, execution engine 108 ensures efficient execution of parallel code 106 on the underlying cluster of computing devices. This is true not only processing requests between various functions, but also within a specific function. Execution engine 108 can map functions/requests to the proper GPU.

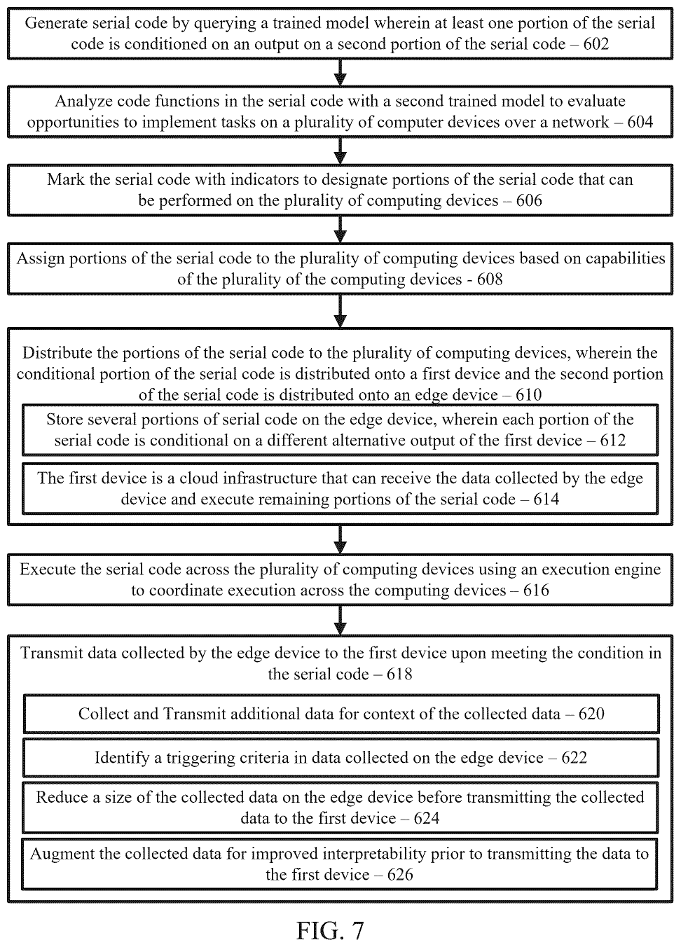

Referring to FIG. 7, a flow diagram demonstrating a method for generating and executing the distributed code is illustrated. The distributed code can be considered a parallel version of the serial code or portions of the serial code in a distributed manner. In block 602, serial code is generated by querying a trained model, wherein at least one portion of the serial code is conditioned on an output on a second portion of the serial code. Conditioned can mean that all or a part of the portion of serial code can be dependent on the output on a conditioning portion of the code. The conditioned code can be performed, not performed, performed in part, performed in a particular manner etc., based on the conditions. For example, some code can be to detect litter on the ocean floor. Once litter is detected, other code can be conditional on the litter being detected to conditioned to categorize, classify, or otherwise label, or otherwise process the type of litter and document the litter location. If litter is not detected, the condition to categorize and document the location of the litter is not met, and those actions later are not performed.

In block 604, code functions are analyzed in the serial code with a second trained model to evaluate opportunities to implement tasks on a plurality of computer devices over a network. The second trained model can be the same model as the trained model in block 602, though this is not a requirement. For example, the serial code can be analyzed to determine portions that are related to object detection of litter, and other portions that are related to litter location processing, etc.

The code dependencies can be direct or transitive. Additionally, the dependencies can be critical or convenient, etc. The serial code is evaluated to determine which functions are dependent on one another or otherwise need to be performed sequentially and which functions can be performed in parallel. This can be done by evaluating whether there is read after write dependencies (RAW), write after read dependencies (WAR), or write after write dependencies (WAW). Alternative embodiments of the present invention can also evaluate whether there is sufficient workload including considerations such as, e.g., thread/process creation, context switching, synchronization, data transfer, Amdahl's Law, and the type of parallelism (e.g., embarrassingly parallel, data parallelism, task parallelism, pipelining). Even further embodiments of the present invention can consider shared states and synchronization, and input/output operations.

In block 606, the serial code is marked with indicators to designate portions of the serial code that can be performed on the plurality of computing devices. In other words, the markers (e.g., markings, indicators, etc.) can be embedded in the code such as functions in the code, comments in the code, compiler and preprocessor markers, test markers, documentation markers, instrumentation markers, semantic and language markers. Other means of marking the code are also contemplated. Portions of the code that are intended to be performed on one particular device due to hardware capabilities or connected sensors, can have semantic indicators reflecting such use. For example, code for object detection can have a semantic indicator reflecting that the portion of the serial code is to be near the camera where an image of the object is captured.

In block 608, portions of the serial code are assigned to the plurality of computing devices based on capabilities of the plurality of the computing devices. The capabilities can be computing power, electrical power, connectivity constraints, memory, etc. A scheduler can aid in assigning the computing devices to portions of the serial code, but the assigning can also be adaptive. In other words, the computing devices assigned at one point can be reassigned later based on new information. For example, the computing devices can be shared among several serial codes such as another code uses the assigned computing device. Alternatively, if more urgent or precedential code is assigned the portion can be allocated to another computing device to avoid disrupting the code. In another example, code analyzing litter patterns on the ocean floor can be assigned based on the computational capabilities of each task.

In block 610, the portions of the serial code are distributed to the plurality of computing devices, where the conditional portion of the serial code is distributed onto a first device and the second portion of the serial code is distributed onto an edge device. The edge device can be connected to sensors, can have locomotion capabilities, can have data processing capabilities, can have communication and data transmission capabilities, etc. Other computing devices can be edge devices or in a cloud, or some combination. The network can be a mesh network, or fog network. The edge device sensors can detect and record sound, light, electromagnetic radiation, temperature, humidity, motion, change in motion, change in velocity, electrical pulses, rotation, etc. The first device can be a cloud device or another edge device. For example, the input and object detection of ocean litter can be on the edge device while processing and post processing, such as, e.g., litter patterns based on ocean currents, etc., can be on cloud infrastructure.

In block 612, several portions of serial code are stored on the edge device, where each portion of the serial code is conditional on a different alternative output of the first device. In other words, the edge device can have several alternative portions of serial code on standby to execute depending on the output of the first device. This can save time and computational resources generating, marking, distributing, and transmitting code in response to the output of the first device. The edge device can receive an output from the first device and immediately begin executing the appropriate conditional code accordingly. Several different portions of code can be loaded. For example, in response to identifying an object that looks like litter, the edge device can receive an output from the first device that this is litter, an output that this is not litter, an output that is potentially litter. From these outputs, the edge device can document the location and likely direction the litter came from, ignore, or investigate further, respectively.

In block 614, the first device is a cloud infrastructure that can receive data collected by the edge device and execute remaining portions of the serial code. In some embodiments of the present invention, only one portion of the serial code is on the edge device. In other embodiments of the present invention, several portions of serial code can be on both the edge device and the cloud, respectively. In even further embodiments of the present invention portions of the serial code can be on several edge devices, which work in conjunction with one another, or several edge devices and the cloud infrastructure.

In block 616, the serial code is executed across the plurality of computing devices using an execution engine to coordinate execution across the plurality of computing devices. The execution engine can assign portions of the code based on the hardware or other considerations such as hot code paths, etc. The execution engine can be adaptive to system and user needs, such as, e.g., modifying the execution to accommodate other tasks, canceling tasks based on user prompt or additional information, etc. For example, if the edge device is tasked with identifying the source of litter in a region, once the edge device discovers a pier with tourists, the execution engine can stop further litter discovery.

In block 618, the edge device transmits data collected to the first device upon meeting the condition in the serial code. The condition can be recognizing an object, sensing something at or above a predetermined threshold. Other methods of initiating conditional code are also contemplated. Once the code meets the criteria the data collected can be transmitted for further processing. The transmission can be in batches, in real-time, or a combination thereof. The edge device can transmit in real-time if there a condition is met, and once the condition is no longer met, the real-time transmission ceases. For example, the edge device can identify litter falling from a pier and begin transmitting a video feed of the litter while in the presence of the edge device, and once the litter stops coming from the pier, the edge device can stop the video feed.

In block 620, the edge device can collect and transmit additional data for context of the collected data. Additional data can include metadata or environmental data. Context of the collected data can provide information that is not readily apparent. For example, additional data for context can be prompted by noticing a large amount of litter in a particular part of the ocean floor. Additional data can be the location, time of day, temperature, current direction, topography of the ocean floor, etc. The additional data can also include exploring the surrounding area to determine if there is a common source of litter. Other forms of collecting additional data are also contemplated.

In block 622, a triggering criteria (or criterion) can be identified in data collected on the edge device. The triggering criteria can be the same as the condition for the conditional code. The triggering criteria can also derived therefrom or different from the condition. In other words, the triggering criteria can be binary such as detecting movement (e.g., a change in position), sound, change in temperature. The triggering criteria can be more involved such as detecting and identifying an object or the condition meets additional criteria. For example, the condition can be identifying litter while the triggering criteria can be identifying three separate pieces of litter in a given region. In even other embodiments of the present invention the triggering criteria can be the lapse of a certain time (e.g., a timed schedule), a notification or request from the code to process data, tickers (e.g., counting the occurrence of something a given number of times), etc.

In block 624, the collected data is reduced in size on the edge device before transmitting the collected data to the first device. The reduction in collected data size can include compression, such as, e.g., lossy or lossless compression, image cropping, filtering, sampling, etc. The edge device can perform some or all processing or pre-processing of the collected data. The edge device can perform some functions to make the transmission or processing of the data easier by reducing the size of the collected data.

In block 626, the collected data can be augmented for improved interpretability prior to transmitting the data to the first device. The augmentation can be applying filters, rotating images, supplying additional views of the same object, etc. Other ways to augment data are also contemplated.

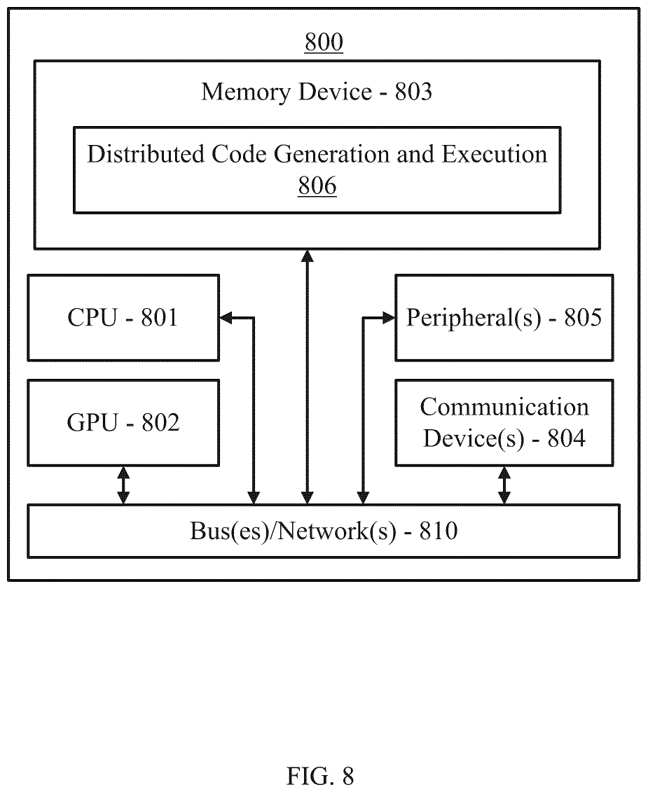

Referring to FIG. 8, a block diagram is shown for an exemplary processing system 800, in accordance with an embodiment of the present invention. The processing system 800 includes a set of processing units (e.g., CPUs) 801, a set of GPUs 802, a set of memory devices 803, a set of communication devices 804, and a set of peripherals 805. CPUs 801 can be single or multi-core CPUs. The GPUs 802 can be single or multi-core GPUs. The one or more memory devices 803 can include caches, RAMs, ROMs, and other memories (flash, optical, magnetic, etc.). The communication devices 804 can include wireless and/or wired communication devices (e.g., network (e.g., Wi-Fi®, etc.) adapters, etc.). The peripherals 805 can include a display device, a user input device, a printer, an imaging device, and so forth. Elements of processing system 800 are connected by one or more buses or networks (collectively denoted by the figure reference numeral 810).

In an embodiment of the present invention, memory devices 803 can store specially programmed software modules to transform the computer processing system into a special purpose computer configured to implement various embodiments of the present invention. In an embodiment, special purpose hardware (e.g., Application Specific Integrated Circuits, Field Programmable Gate Arrays (FPGAs), and so forth) can be used to implement various embodiments of the present invention.

In an embodiment, memory devices 803 store program code or software 806 for distributed code generation and execution for real-time execution. The code generation and execution implement one or more functions of the systems and methods described herein for generating and initiating distributed code. The generation and execution software 806 includes generating serial code by querying a trained model wherein at least one portion of the serial code is conditioned on an output on a second portion of the serial code, analyzing code functions in the serial code with a second trained model to evaluate opportunities to implement tasks on a plurality of computer devices over a network, marking the serial code with indicators to designate portions of the serial code that can be performed on the plurality of computing devices, and assigning portions of the serial code to the plurality of computing devices based on capabilities of the plurality of the computing devices.

Also, software 806 includes distributing the portions of the serial code to the plurality of computing devices, wherein the conditional portion of the serial code is distributed onto a first device and the second portion of the serial code is distributed onto an edge device, executing the serial code across the plurality of computing devices using an execution engine to coordinate execution across the plurality of computing devices, and transmitting data collected by the edge device to the first device upon meeting the condition in the serial code. The memory devices 803 can store program code for implementing one or more functions of the systems and methods described herein.

Of course, the processing system 800 may also include other elements (not shown), as readily contemplated by one of skill in the art, as well as omitting certain elements. For example, various other input devices and/or output devices can be included in processing system 800, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 800 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 800.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

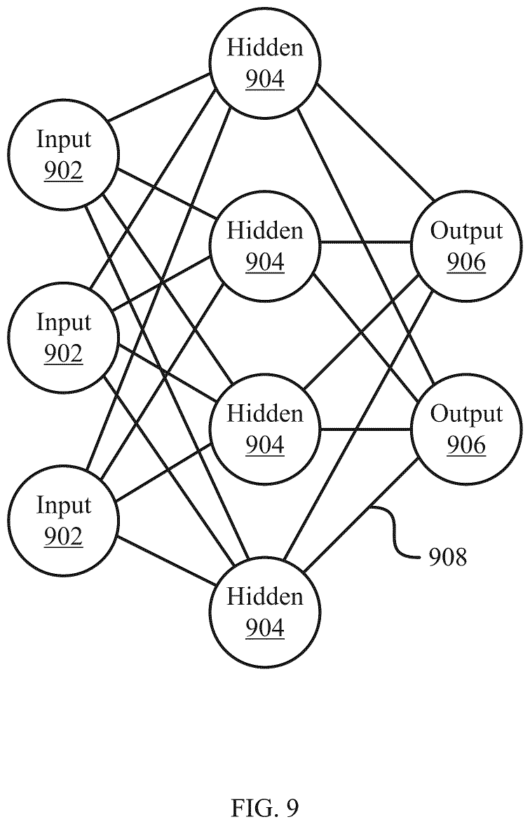

Referring now to FIG. 9, a generalized diagram of a neural network is shown. An artificial neural network (ANN) is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process. The ANN can identify patterns in text or other forms of communication and form embeddings for future processing. These patterns can relate actions and objects, relate objects to other objects, or actions to other actions. The ANN can identify seemingly unrelated or innocuous patterns or relationships with correlations. The ANN can bound objects into bounding boxes, extract objects from bounding boxes, classify actions, embed objects from features, and extract actions from text, among other capabilities.

Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 902 that provide information to one or more “hidden” neurons 904. Connections 908 between the input neurons 902 and hidden neurons 904 are weighted, and these weighted inputs are then processed by the hidden neurons 904 according to some function in the hidden neurons 904. There can be any number of layers of hidden neurons 904, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 906 accepts and processes weighted input from the hidden neurons 904.

This represents a “feed-forward” computation, where information propagates from input neurons 902 to the output neurons 906. Upon completion of a feed-forward computation, the output is compared to a desired output available from training data. The error relative to the training data is then processed in “backpropagation” computation, where the hidden neurons 904 and input neurons 902 receive information regarding the error propagating backward from the output neurons 906. Once the backward error propagation has been completed, weight updates are performed, with the weighted connections 908 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each connection 908 weight may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs.

The ANN can be integrated into distributed code generation and execution by generating the code. LLMs are a type of ANN. LLM code generator 104 (FIG. 2), output verifier 302 (FIG. 4), and prompt generator 304 (FIG. 4). There can be several modules in the ANN that can perform the same, similar, or different tasks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for generating and executing serial code in a distributed manner, comprising:
generating serial code by querying a trained model wherein at least one portion of the serial code is conditioned on an output on a second portion of the serial code;
analyzing code functions in the serial code with a second trained model to evaluate opportunities to implement tasks on a plurality of computer devices over a network;
marking the serial code with indicators to designate portions of the serial code that can be performed on the plurality of computing devices;
assigning portions of the serial code to the plurality of computing devices based on capabilities of the plurality of the computing devices;
distributing the portions of the serial code to the plurality of computing devices, wherein the conditional portion of the serial code is distributed onto a first device and the second portion of the serial code is distributed onto an edge device;
executing the serial code across the plurality of computing devices using an execution engine to coordinate execution across the plurality of computing devices; and
transmitting data collected by the edge device to the first device upon meeting the condition in the serial code.

2. The method of claim 1, wherein the first device is a cloud infrastructure that can receive the data collected by the edge device and execute remaining portions of the serial code.

3. The method of claim 1, further comprising:
collecting and transmitting additional data for context of the collected data.

4. The method of claim 1, wherein executing the conditional serial code further comprises:
identifying a triggering criteria in data collected on the edge device.

5. The method of claim 1, wherein executing the serial code further comprises:
storing several portions of serial code on the edge device, wherein each portion of the serial code is conditional on a different alternative output of the first device.

6. The method of claim 1, further comprising:
reducing a size of the collected data on the edge device before transmitting the collected data to the first device.

7. The method of claim 1, further comprising:
augmenting the collected data for improved interpretability prior to transmitting the data to the first device.

8. A system for generating and executing distributed code, comprising:
a processor; and
a memory storing computer-readable instructions that, when executed by the processor, cause the system to:
generate serial code by querying a trained model wherein at least one portion of the serial code is conditioned on an output on a second portion of the serial code;
analyze code functions in the serial code with a second trained model to evaluate opportunities to implement tasks on a plurality of computer devices over a network;
mark the serial code with indicators to designate portions of the serial code that can be performed on the plurality of computing devices;
assign portions of the serial code to the plurality of computing devices based on capabilities of the plurality of the computing devices;
distribute the portions of the serial code to the plurality of computing devices, wherein the conditional portion of the serial code is distributed onto a first device and the second portion of the serial code is distributed onto an edge device;
execute the serial code across the plurality of computing devices using an execution engine to coordinate execution across the plurality of computing devices; and
transmit data collected by the edge device to the first device upon meeting the condition in the serial code.

9. The system of claim 8, wherein the first device is a cloud infrastructure that can receive the data collected by the edge device and execute remaining portions of the serial code.

10. The system of claim 8, wherein the memory further causes the system to:
collect and transmit additional data for context of the collected data.

11. The system of claim 8, wherein the memory further causes the system to:
identify a triggering criteria in data collected on the edge device.

12. The system of claim 8, wherein the memory further causes the system to:
store several portions of serial code on the edge device, wherein each portion of the serial code is conditional on a different alternative output of the first device.

13. The system of claim 8, wherein the memory further causes the system to:
reduce a size of the collected data on the edge device before transmitting the collected data to the first device.

14. The system of claim 8, wherein the memory further causes the system to:
augment the collected data for improved interpretability prior to transmitting the data to the first device.

15. A computer program product comprising a non-transitory computer-readable storage medium containing computer program code, the computer program code when executed by one or more processors causes the one or more processors to perform operations, the computer program code comprising instructions to:
generate serial code by querying a trained model wherein at least one portion of the serial code is conditioned on an output on a second portion of the serial code;
analyze code functions in the serial code with a second trained model to evaluate opportunities to implement tasks on a plurality of computer devices over a network;
mark the serial code with indicators to designate portions of the serial code that can be performed on the plurality of computing devices;
assign portions of the serial code to the plurality of computing devices based on capabilities of the plurality of the computing devices;
distribute the portions of the serial code to the plurality of computing devices, wherein the conditional portion of the serial code is distributed onto a first device and the second portion of the serial code is distributed onto an edge device;
execute the serial code across the plurality of computing devices using an execution engine to coordinate execution across the plurality of computing devices; and
transmit data collected by the edge device to the first device upon meeting the condition in the serial code.

16. The computer program product of claim 15, wherein the first device is a cloud infrastructure that can receive the data collected by the edge device and execute remaining portions of the serial code.

17. The computer program product of claim 15, wherein the computer program code further comprises instructions to:
collect and transmit additional data for context of the collected data.

18. The computer program product of claim 15, wherein the computer program code further comprises instructions to:
identify a triggering criteria in data collected on the edge device.

19. The computer program product of claim 15, wherein the computer program code further comprises instructions to:
store several portions of serial code on the edge device, wherein each portion of the serial code is conditional on a different alternative output of the first device.

20. The computer program product of claim 15, wherein the computer program code further comprises instructions to:
reduce a size of the collected data on the edge device before transmitting the collected data to the first device.
